(19) United States
(12) Patent Application Publication
(10) Pub. No.: US 2023/0193672 A1
(43) Pub. Date: Jun. 22, 2023

(54) HINGE MOUNTING STRUCTURE

(71) Applicant: SUGATSUNE KOGYO CO., LTD., Tokyo (JP)

(72) Inventors: Kazuaki KASHIWAGUMA, Tokyo (JP); Yukihiko OGAWA, Tokyo (JP)

(73) Assignee: SUGATSUNE KOGYO CO., LTD., Tokyo (JP)

(21) Appl. No.: 18/000,116

(22) PCT Filed: Mar. 12, 2021
(86) PCT No.: PCT/JP2021/010017

§ 371 Date: Nov. 28, 2022

(30) Foreign Application Priority Data
May 29, 2020 (JP) 2020-094093

(51) Int. Cl. E05D 3/02; E05D 5/06; E06B 1/04

(52) U.S. Cl. CPC E05D 3/02; E05D 5/06; E06B 1/04

(57) ABSTRACT

A hinge mounting structure is provided in which a door can open at a wide angle. In a hinge mounting structure including a hinge (1) having a first piece (3) and a second piece (4) that are coupled together via a shaft (2) in such a manner as to be rotatable relative to each other, the first piece (3) being mounted on a side jamb (6), the second piece (4) being mounted on an end face of a door (5), the side jamb (6) is provided with a protruding portion (8) protruding forward of a wall surface, and at least a part of the door (5) is backward of a front surface line (X), in an open position of the door (5).

### TECHNICAL FIELD

The present invention relates to a hinge mounting structure used mainly in a building structure.

### BACKGROUND ART

A hinge mounting structure is conventionally known which includes a hinge having a first piece and a second piece that are coupled together via a shaft in such a manner as to be rotatable relative to each other, the first piece being mounted on a side jamb, the second piece being mounted on an end face of a door. In the known hinge mounting structure, the shaft of the hinge is placed forward of the front surface of the side jamb to open the door at a wide angle. However, if the shaft of the hinge is placed in this manner, the shaft of the hinge juts out from the side jamb. Therefore, there is a problem of bad appearance. In order to solve the problem, Patent Literature 1 discloses a hinge mounting structure where a shaft of a hinge is recessed to place the center of the shaft of the hinge in the same position as a front surface line of the side jamb.

### CITATION LIST

### Patent Literature

Patent Literature 1: JP H11-131891 A

### SUMMARY OF INVENTION

### Technical Problem

However, in the hinge mounting structure described in Patent Literature 1, the front surface line of the side jamb and the wall surface are placed in the same plane. Hence, there is a problem that it is hard to open the door at a wide angle.

The present invention has been made considering the above problem, and an object thereof is to provide a hinge mounting structure in which a door can open at a wide angle.

### Solution to Problem

In order to solve the above problem, one aspect of the present invention is a hinge mounting structure including a hinge having a first piece and a second piece that are coupled together via a shaft in such a manner as to be rotatable relative to each other, the first piece being mounted on a side jamb, the second piece being mounted on an end face of a door, in which the side jamb is provided with a protruding portion protruding forward of a wall surface, and at least a part of at least one of the door and/or the second piece is backward of a front surface line of the protruding portion of the side jamb, in an open position of the door.

### Advantageous Effects of Invention

According to the present invention, the at least a part of the at least one of the door and/or the second piece is backward of the front surface line of the protruding portion in the open position of the door; therefore, the door can open at a wide angle.

### BRIEF DESCRIPTION OF DRAWINGS

FIG. 1 is an exploded perspective view of a hinge that is used in a hinge mounting structure of a first embodiment of the present invention.

FIG. 2 is operating diagrams of the hinge (FIG. 2(a) illustrates a closed position of a second piece, FIG. 2(b) illustrates a 90-degree open position of the second piece, and FIG. 2(c) illustrates a 180-degree open position of the second piece).

FIG. 3 is a perspective view of the hinge mounting structure (with a door in an open position).

FIG. 4 is a horizontal cross-sectional view of the hinge mounting structure (with the door in a closed position).

FIG. 5 is a perspective view of a side jamb of the hinge mounting structure.

FIG. 6 is a perspective view of the side jamb and a cover of the hinge mounting structure.

FIG. 7 is a perspective view of the hinge and the door of the hinge mounting structure.

FIG. 8 is a perspective view of the door and the cover of the hinge mounting structure.

FIG. 9 is horizontal cross-sectional views of the hinge mounting structure (FIG. 9(a) illustrates the closed position of the door, FIG. 9(b) illustrates a 90-degree open position of the door, and FIG. 9(c) illustrates a 180-degree open position of the door).

FIG. 10 is a perspective view of the hinge mounting structure (a perspective view from the door side).

FIG. 11 is a perspective view of the hinge mounting structure (a perspective view from a wall side).

FIG. 12 is horizontal cross-sectional views of a hinge mounting structure of a second embodiment of the present invention (FIG. 12(a) illustrates a closed position of a door, FIG. 12(b) illustrates a 90-degree open position of the door, and FIG. 12(c) illustrates a 180-degree open position of the door).

FIG. 13 is a perspective view of a hinge mounting structure of a third embodiment of the present invention (with a door in an open position).

FIG. 14 is a perspective view of a side jamb of the hinge mounting structure.

FIG. 15 is a perspective view of the hinge mounting structure (with the door in a closed position).

### DESCRIPTION OF EMBODIMENTS

Embodiments of a hinge mounting structure of the present invention are described in detail hereinafter with reference to the accompanying drawings. However, the hinge mounting structure of the present invention can be embodied in various modes, and is not limited to the embodiments described in the description. The embodiments are provided with the intention of enabling those skilled in the art to fully understand the invention by fully disclosing the description.

### First Embodiment

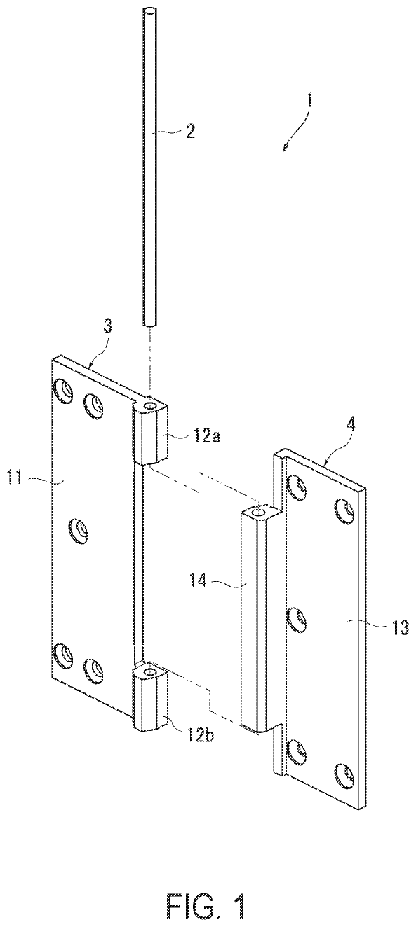

FIG. 1 is an exploded perspective view of a hinge that is used in a hinge mounting structure of a first embodiment of the present invention. A hinge 1 includes a shaft 2, and a first piece 3 and a second piece 4 that are coupled together via the shaft 2 in such a manner as to be rotatable relative to each other. The first piece 3 includes an approximately rectangular main body portion 11, and tubular portions 12a and 12b. The two tubular portions 12a and 12b are formed integrally with an edge in a width direction of the main body portion 11. The second piece 4 includes an approximately rectangular main body portion 13 and a tubular portion 14. The one tubular portion 14 is formed integrally with an edge in a width direction of the main body portion 13. The shaft 2 is inserted into the tubular portions 12a and 12b of the first piece 3 and the tubular portion 14 of the second piece 4. The tubular portion 14 of the second piece 4 is placed between the tubular portions 12a and 12b of the first piece 3.

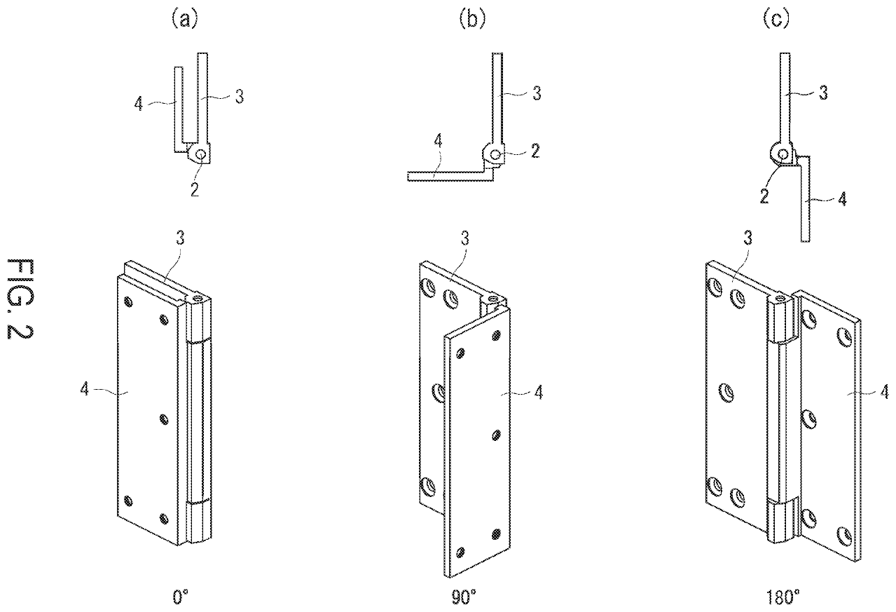

FIG. 2 is operating diagrams of the hinge 1. The upper part of FIG. 2 represents a plan view of the hinge 1, and the lower part of FIG. 2 represents a perspective view of the hinge 1. FIG. 2(a) illustrates a closed position (a 0-degree open position) of the second piece 4, FIG. 2(b) illustrates a 90-degree open position of the second piece 4, and FIG. 2(c) illustrates a 180-degree open position of the second piece 4. The second piece 4 can rotate from 0 degrees to 180 degrees relative to the first piece 3.

In plan view, the first piece 3 has an I-shape, and the second piece 4 has an L-shape. The main body portion 11 of the first piece 3 is parallel to the main body portion 13 of the second piece 4 (the long-side side of the main body portion of the L-shape) in the closed position of the second piece 4. The first piece 3 is orthogonal to the second piece 4 in the 90-degree open position of the second piece 4. The first piece 3 and the second piece 4 are in an unfolded state and are parallel to each other, in the 180-degree open position of the second piece 4.

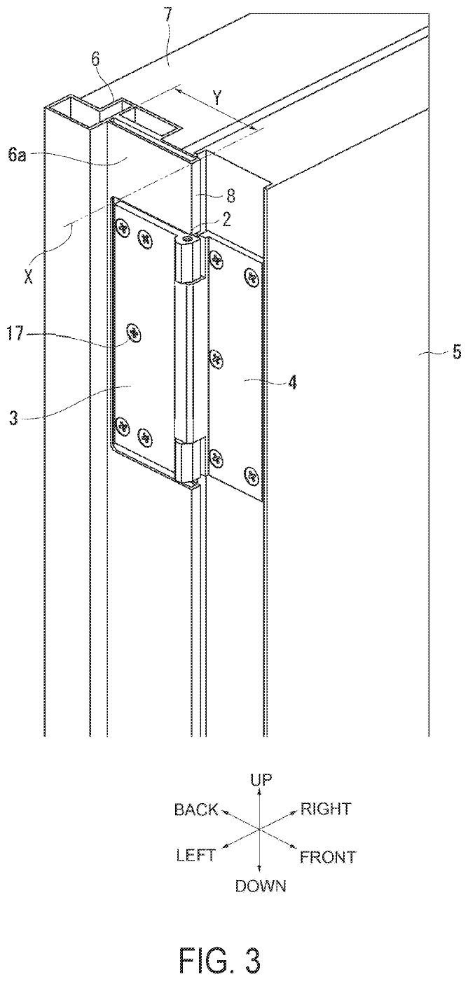

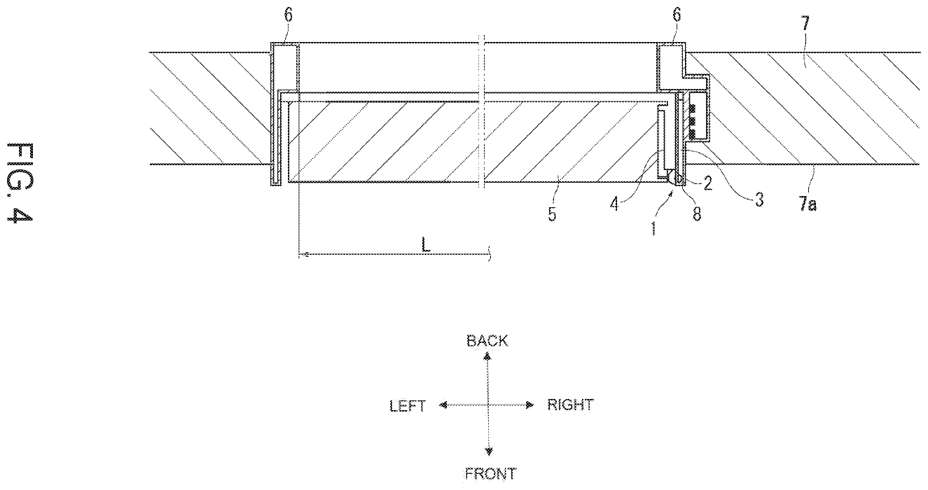

FIG. 3 is a perspective view of the hinge mounting structure of the embodiment (with a door 5 in an open position). FIG. 4 is a horizontal cross-sectional view of the hinge mounting structure of the embodiment (with the door 5 in a closed position). For convenience of description, the directions in a front view from the opening side of the door 5 in the closed position, that is, the directions of front and back, up and down, and left and right in FIGS. 3 and 4 are used below to describe the hinge mounting structure.

The first piece 3 of the hinge 1 is mounted on one of side jambs 6, 6 (refer to FIG. 4) placed to the left and right of the door 5. The second piece 4 of the hinge 1 is mounted on an end face of the door 5. The side jamb 6 is mounted on a wall 7. The side jamb 6 is provided with a protruding portion 8 protruding forward of a wall surface 7a. The protruding portion 8 extends beyond the height of the door 5 in the up-and-down direction. The side jamb 6 includes, in an inside surface thereof, an appropriately deep cut portion 6a formed with a depth Y greater than the thickness of the door 5.

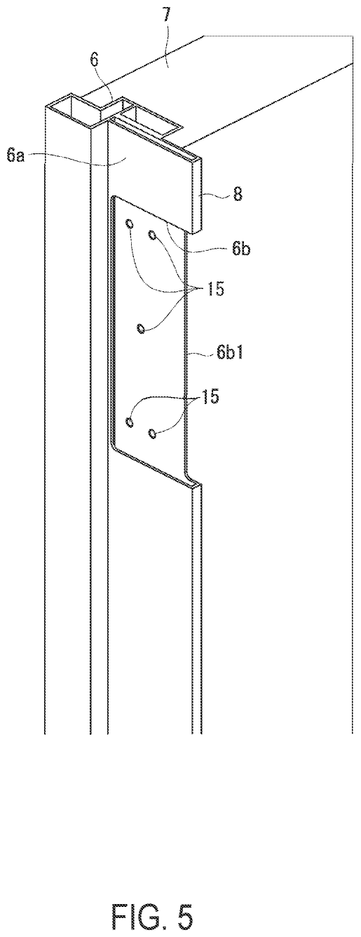

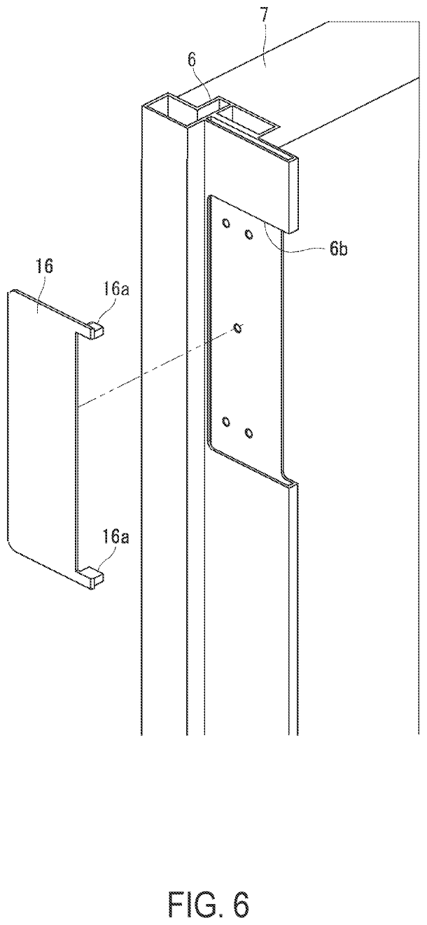

As illustrated in FIG. 5, the cut portion 6a of the side jamb 6 includes a rectangular recessed portion 6b formed therein. The first piece 3 is mounted in the recessed portion 6b. A reference sign 15 denotes a screw hole into which a screw 17 (refer to FIG. 3) is screwed. A part 6b1 (a front end) of the recessed portion 6b penetrates the protruding portion 8 of the side jamb 6 in the left-and-right direction, which facilitates the placement of the shaft 2 (refer to FIG. 3) of the hinge 1 in the protruding portion 8. As illustrated in FIG. 6, the recessed portion 6b is covered with a cover 16 after the first piece 3 is mounted in the recessed portion 6b. Consequently, the appearance can be improved while the screw 17 is hidden. The cover 16 is detachably mounted on the side jamb 6 by use of a hook 16a of the cover 16. The frame of the embodiment is made of metal such as aluminum or sheet metal. However, the material of the side jamb 6 is not particularly limited. Moreover, the recessed portion 6b may be formed in the front surface of the protruding portion 8.

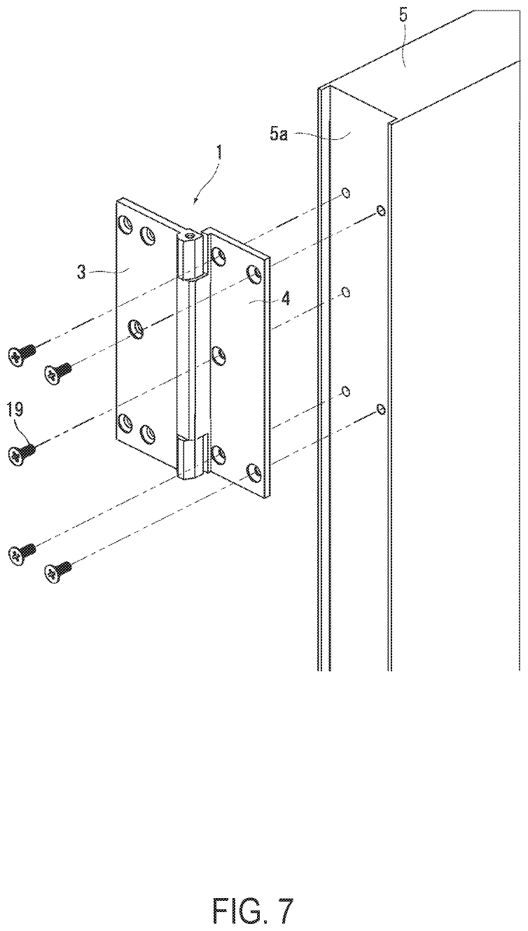

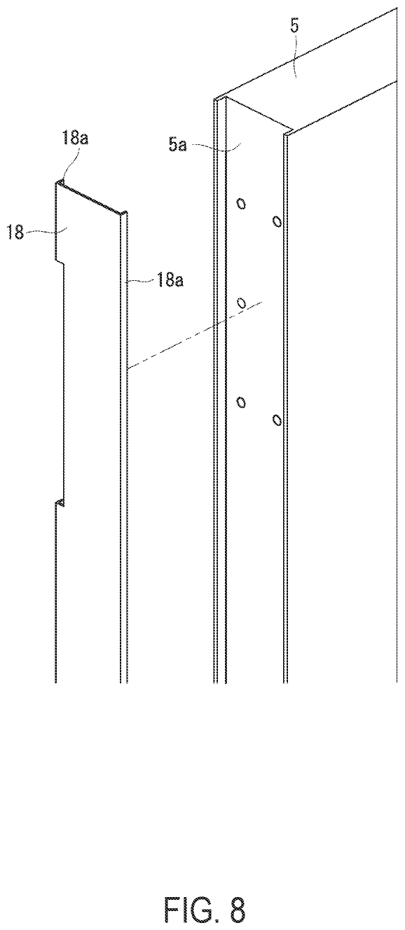

As illustrated in FIG. 7, a recessed portion 5a extending in the up-and-down direction is formed in the end face of the door 5. The second piece 4 is mounted in the recessed portion 5a. As illustrated in FIG. 8, the recessed portion 5a is covered with a cover 18 after the second piece 4 is mounted in the recessed portion 5a. Consequently, the appearance can be improved while a screw 19 (refer to FIG. 7) is hidden. The cover 18 is detachably mounted on the door 5 by use of a hook 18a of the cover 18.

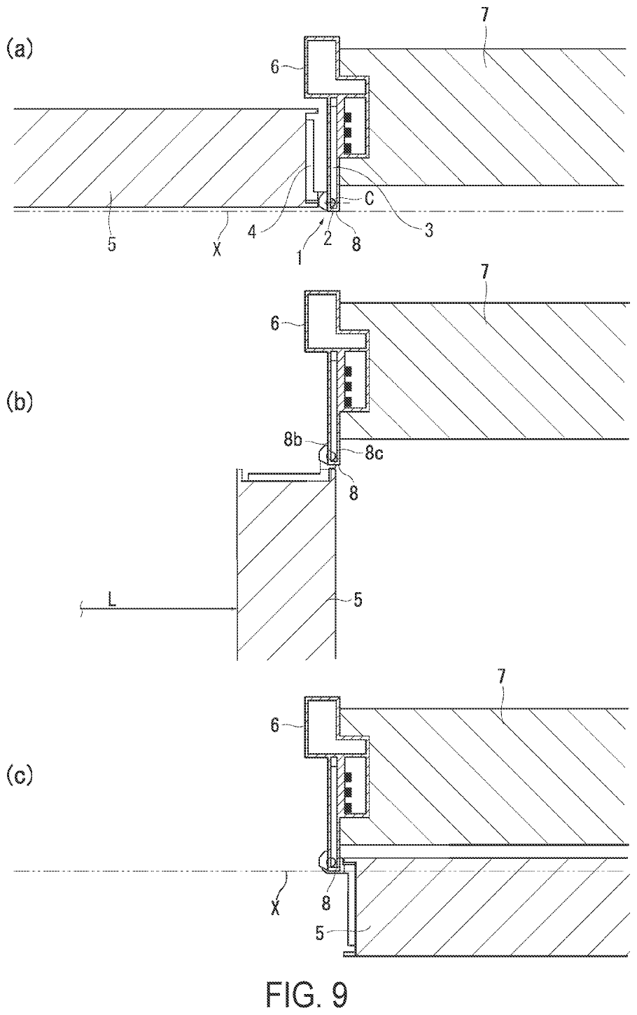

FIG. 9 represents horizontal cross-sectional views of the hinge mounting structure of the embodiment. FIG. 9(a) illustrates the closed position of the door 5, FIG. 9(b) illustrates a 90-degree open position of the door 5, and FIG. 9(c) illustrates a 180-degree open position of the door 5. In the embodiment, a center C of the shaft 2 of the hinge 1 is placed backward of a front surface line X of the protruding portion 8 as illustrated in FIG. 9(a). Consequently, it is possible to make the hinge 1 inconspicuous, and to improve the appearance.

As illustrated in FIG. 9(a), the door 5 in the closed position is backward of the front surface line X of the protruding portion 8. When the door 5 in the closed position illustrated in FIG. 9(a) rotates to the open position, the door 5 goes over the protruding portion 8. A part of the door 5 is backward of the front surface line X of the protruding portion 8 in the open position of the door 5 as illustrated in FIG. 9(c). Consequently, the door 5 can open at a wide angle. The opening angle of the door 5 in the open position is not limited to 180 degrees, and can be any angle such as 190 degrees or 170 degrees.

The center C of the shaft 2 is placed between an inside surface 8b and an outside surface 8c of the protruding portion 8 as illustrated in FIG. 9(b). Consequently, an opening dimension L (refer also to FIG. 4) can be increased in the 90-degree open position of the door 5.

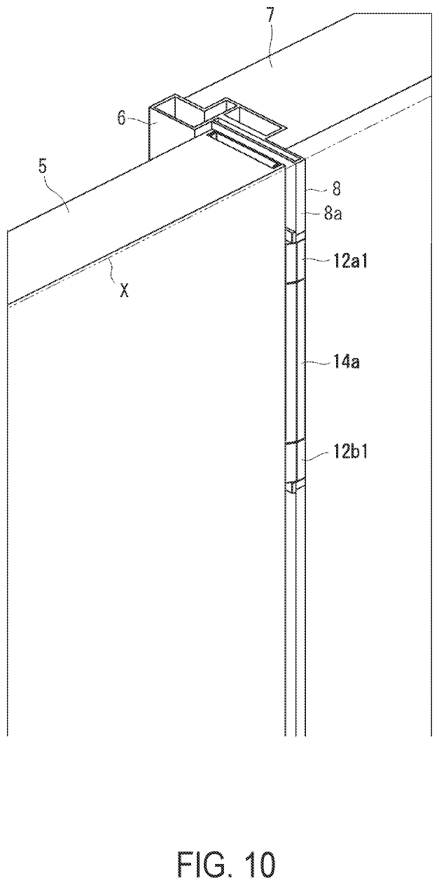

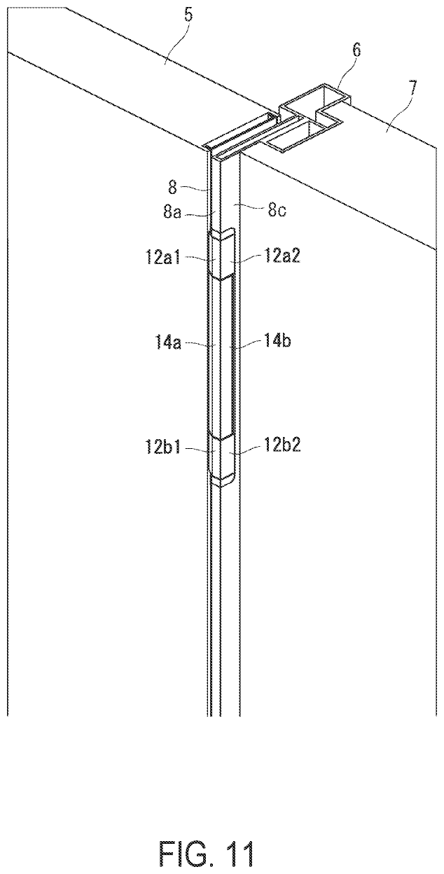

FIGS. 10 and 11 are perspective views of the hinge mounting structure of the embodiment (with the door 5 in the closed position) FIG. 10 is a perspective view from the door 5 side, and FIG. 11 is a perspective view from the wall side.

As illustrated in FIG. 10, front surfaces 12a1 and 12b1 of the tubular portions 12a and 12b of the first piece 3, and a front surface 14a of the tubular portion 14 of the second piece 4 are substantially in the same plane as a front surface 8a of the protruding portion 8, in the closed position of the door 5. As illustrated in FIG. 11, outside surfaces 12a2 and 12b2 of the tubular portions 12a and 12b of the first piece 3, and an outside surface 14b of the tubular portion 14 of the second piece 4 are substantially in the same plane as the outside surface 8c of the protruding portion 8, in the closed position of the door 5.

Consequently, the appearance can be improved. The front surface 8a and the outside surface 8c of the protruding portion 8 are at right angles. The front surfaces 12a1 and 12b1 and the outside surfaces 12a2 and 12b2 of the tubular portions 12a and 12b of the first piece 3 are at right angles. The front surface 14a and the outside surface 14b of the tubular portion 14 of the second piece 4 are at right angles.

Each of the front surface 8a and the outside surface 8c of the protruding portion 8, the front surfaces 12a1 and 12b1 and the outside surfaces 12a2 and 12b2 of the tubular portions 12a and 12b of the first piece 3, and the front surface 14a and the outside surface 14b of the tubular portion 14 of the second piece 4 is formed into a flat surface, but may be formed into a curved surface of, for example, an arc shape in horizontal cross section.

### Second Embodiment

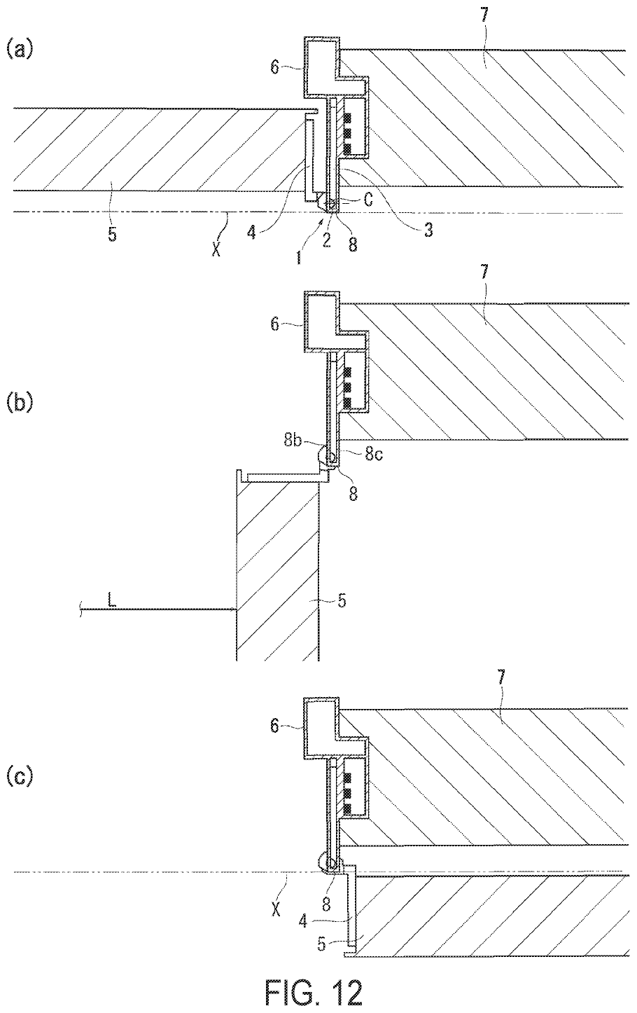

FIG. 12 represents horizontal cross-sectional views of a hinge mounting structure of a second embodiment of the present invention. FIG. 12(a) illustrates a closed position of a door 5, FIG. 12(b) illustrates a 90-degree open position of the door 5, and FIG. 12(c) illustrates a 180-degree open position of the door 5. The configurations of a wall 7, a side jamb 6, and a hinge 1 are the same as those of the hinge mounting structure of the first embodiment. Therefore, the same reference signs are assigned thereto, and descriptions thereof are omitted.

As illustrated in FIG. 12(a), also in the hinge mounting structure of the second embodiment, the center C of the shaft 2 of the hinge 1 is placed backward of the front surface line X of the protruding portion 8 as in the hinge mounting structure of the first embodiment. Moreover, as illustrated in FIG. 12(b), the center C of the shaft 2 is placed between the inside surface 8b and the outside surface 8c of the protruding portion 8.

In the hinge mounting structure of the first embodiment, a part of the door 5 is backward of the front surface line X in the open position of the door 5. In contrast, in the hinge mounting structure of the second embodiment, a part of the second piece 4 of the hinge 1 is backward of the front surface line X in the open position of the door 5 as illustrated in FIG. 12(c).

The door 5 in the closed position is backward of the front surface line X of the protruding portion 8 as illustrated in FIG. 12(a). When the door 5 in the closed position illustrated in FIG. 12(a) rotates to the open position, the door 5 goes over the protruding portion 8. The part of the second piece 4 of the hinge 1 is backward of the front surface line X of the protruding portion 8 in the open position of the door 5 as illustrated in FIG. 12(c). Consequently, the door 5 can open at a wide angle. The opening angle of the door 5 in the open position is not limited to 180 degrees, and can be any angle such as 190 degrees or 170 degrees.

### Third Embodiment

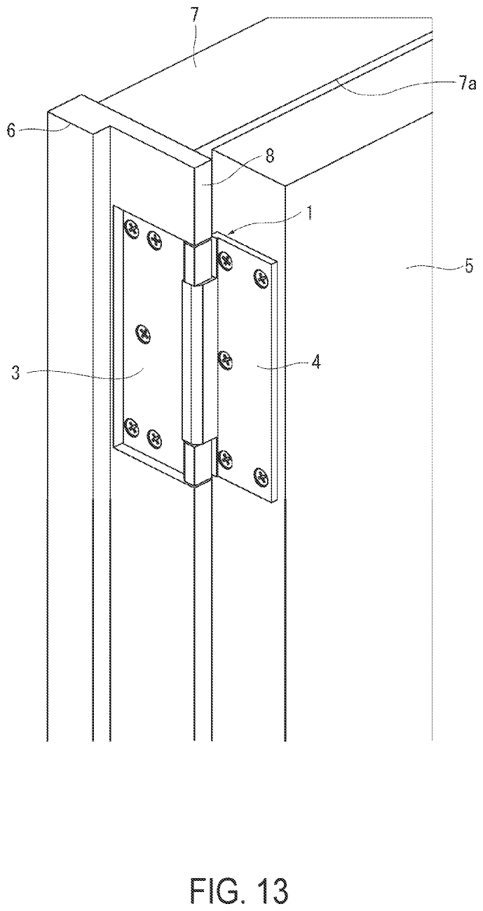

FIGS. 13 to 15 illustrate a hinge mounting structure of a third embodiment of the present invention. The side jamb 6 is made of metal in the first embodiment, whereas the side jamb 6 is made of wood in the third embodiment. The configuration of the hinge 1 is substantially the same as that of the hinge 1 of the first embodiment and therefore the same reference signs are assigned thereto, and descriptions thereof are omitted.

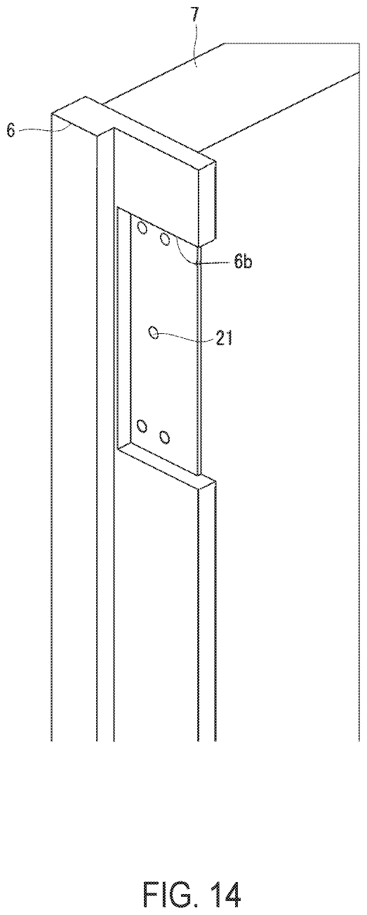

As illustrated in FIG. 13, the first piece 3 of the hinge 1 is mounted on the side jamb 6 with a screw. The second piece 4 of the hinge 1 is mounted on an end face of a door 5 with a screw. The side jamb 6 is provided with a protruding portion 8 protruding forward of a wall surface 7a. As illustrated in FIG. 14, the side jamb 6 includes a recessed portion 6b formed in an inside surface thereof. The first piece 3 is mounted in the recessed portion 6b. A reference sign 21 denotes a screw hole into which the screw is screwed.

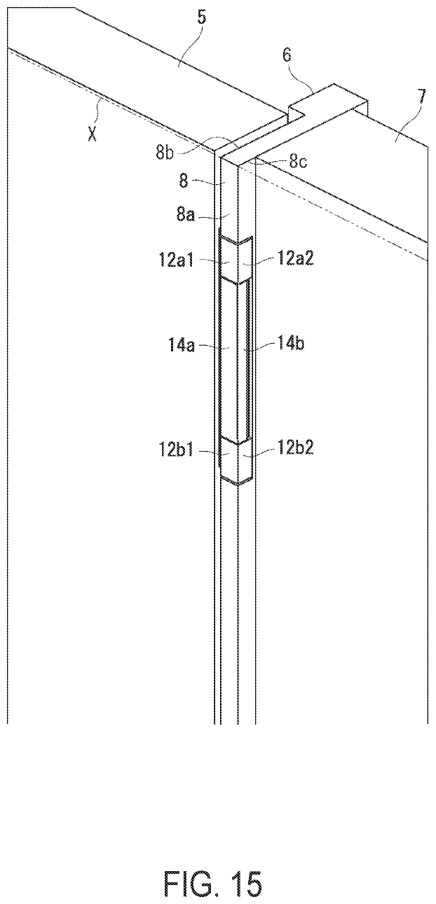

FIG. 15 is a perspective view of the hinge mounting structure of the embodiment (with the door 5 in a closed position). The center C (refer to FIG. 9(a)) of the shaft 2 of the hinge 1 is placed backward of a front surface line X of the protruding portion 8 as in the first embodiment. Moreover, the center C of the shaft 2 of the hinge 1 is placed between an inside surface 8b and an outside surface 8c of the protruding portion 8. In the closed position of the door 5, the front surfaces 12a1 and 12b1 of the tubular portions 12a and 12b of the first piece 3, and the front surface 14a of the tubular portion 14 of the second piece 4 are substantially in the same plane as a front surface 8a of the protruding portion 8, and the outside surfaces 12a2 and 12b2 of the tubular portions 12a and 12b of the first piece 3, and the outside surface 14b of the tubular portion 14 of the second piece 4 are substantially in the same plane as the outside surface 8c of the protruding portion 8. The hinge mounting structure of the third embodiment exerts similar effects to the hinge mounting structure of the first embodiment.

The present description is based on Japanese Patent Application No. 2020-094093 filed on May 29, 2020, the entire contents of which are incorporated herein.

### REFERENCE SIGNS LIST

1 Hinge
2 Shaft
3 First piece
4 Second piece
5 Door
6 Side jamb
6b Recessed portion
7a Wall surface
8 Protruding portion
8a Front surface of protruding portion
8c Outside surface of protruding portion
12a, 12b Tubular portion
12a1, 12b1 Front surface of tubular portion
12a2, 12b2 Outside surface of tubular portion
14 Tubular portion
14a Front surface of tubular portion
14b Outside surface of tubular portion
16 Cover
C Center of shaft
X Front surface line of protruding portion

1. A hinge mounting structure comprising a hinge including a first piece and a second piece that are coupled together via a shaft in such a manner as to be rotatable relative to each other, the first piece being mounted on a side jamb, the second piece being mounted on an end face of a door, wherein
the side jamb is provided with a protruding portion protruding forward of a wall surface, and
at least a part of at least one of the door and/or the second piece is backward of a front surface line of the protruding portion, in an open position of the door.

2. The hinge mounting structure according to claim 1, wherein a center of the shaft is placed between an inside surface and an outside surface of the protruding portion of the side jamb.

3. The hinge mounting structure according to claim 1, wherein at least one of a front surface of a tubular portion, into which the shaft is inserted, of the first piece and/or a front surface of a tubular portion, into which the shaft is inserted, of the second piece is placed substantially in the same plane as a front surface of the protruding portion, in a closed position of the door.

4. The hinge mounting structure according to claim 1, wherein at least one of an outside surface of the tubular portion, into which the shaft is inserted, of the first piece and/or an outside surface of the tubular portion, into which the shaft is inserted, of the second piece is placed substantially in the same plane as the outside surface of the protruding portion, in the closed position of the door.

5. The hinge mounting structure according to claim 1, wherein the first piece is placed in a recessed portion provided in the side jamb.

6. The hinge mounting structure according to claim 5, wherein a part of the recessed portion penetrates the side jamb in a left-and-right direction.

7. The hinge mounting structure according to claim 5, wherein the recessed portion is covered with a cover.

8. The hinge mounting structure according to claim 2, wherein at least one of a front surface of a tubular portion, into which the shaft is inserted, of the first piece and/or a front surface of a tubular portion, into which the shaft is inserted, of the second piece is placed substantially in the same plane as a front surface of the protruding portion, in a closed position of the door.

9. The hinge mounting structure according to claim 2, wherein at least one of an outside surface of the tubular portion, into which the shaft is inserted, of the first piece and/or an outside surface of the tubular portion, into which the shaft is inserted, of the second piece is placed substantially in the same plane as the outside surface of the protruding portion, in the closed position of the door.

10. The hinge mounting structure according to claim 2, wherein the first piece is placed in a recessed portion provided in the side jamb.

11. The hinge mounting structure according to claim 10, wherein a part of the recessed portion penetrates the side jamb in a left-and-right direction.

12. The hinge mounting structure according to claim 10, wherein the recessed portion is covered with a cover.
